(19) United States
(12) Patent Application Publication
(10) Pub. No.: US 2009/0321356 A1
(43) Pub. Date: Dec. 31, 2009

(54) CERAMIC-BASED CHROMATOGRAPHY APPARATUS AND METHODS FOR MAKING SAME

(75) Inventors: Geoff C. Gerhardt, Millbury, MA (US); Joseph Michienzi, Plainville, MA (US); Christopher C. Benevides, Tiverton, RI (US)

Correspondence Address: Waters Technologies Corporation;C/O WATERS CORPORATION, 34 MAPLE STREET - LG, MILFORD, MA, 01757, US

(73) Assignee: WATERS INVESTMENTS LIMITED, New Castle, DE (US)

(21) Appl. No.: 12/282,225

(22) PCT Filed: Mar. 19, 2007
(86) PCT No.: PCT/US07/64267

§ 371 Date: Apr. 8, 2009

Related U.S. Application Data
(60) Provisional application No. 60/785,866, filed on Mar. 24, 2006.

(51) Int. Cl. B01D 15/22; B01D 15/36; B01D 15/26

(52) U.S. Cl. 210/656; 210/198.2; 210/253

(57) ABSTRACT

A high-performance liquid-chromatography apparatus includes a substrate that defines a separation column in fluidic communication with an inlet port of the processing unit. The processing unit is formed of sintered inorganic particles. The apparatus also includes a pump that delivers a solvent to the inlet port at a pressure sufficient for high-performance liquid-chromatography.

### CROSS REFERENCE TO RELATED APPLICATIONS

This application claims benefit of U.S. Provisional Application No. 60/785,866, filed Mar. 24, 2006, (Attorney Docket No. W-451-01) the contents of which are incorporated herein by reference.

### TECHNICAL FIELD

The invention generally relates to tubing used in analytical instruments and other systems, and methods for making such tubing.

### BACKGROUND INFORMATION

Since its inception in the 1970's, traditional HPLC (high-performance liquid chromatography) has typically utilized analytical columns constructed from stainless-steel tubing having an inner bore diameter of 4.7 mm and lengths in a range of about 5 cm to about 25 cm. The selection and continuing use of a 4.7 mm diameter tube is perhaps related to the original availability of steel tubing of various sizes.

To complete an analytical column for an HPLC instrument, a fritted end-fitting is typically attached to a piece of tubing, and the tube is then packed with particles (typically silica-based, functionalized with a variety of functional moieties.)

To achieve optimal separation efficiency, using the completed column, an appropriate flow rate of a mobile phase is important. For a 4.7 mm diameter column packed with 5 μm diameter particles, a desirable flow rate is typically between about 1 mL/min and about 2 mL/min. To maintain separation efficiency, it is also desirable to minimize the presence of unswept dead volume in the plumbing of the HPLC instrument.

In an HPLC instrument, an injector is typically used to inject a sample into a flowing mobile phase as a discrete fluidic plug. Dispersion of a plug band as it travels to and/or from the column reduces the ultimate efficiency of the chromatographic system. For example, in a chromatographic system using 4.7 mm column tubing and a mobile phase flowing at 1-2 mL/min, tubing having an outer diameter of 1/16 inch and an inner diameter of about 0.010 inch is typically used to plumb connections between the various HPLC components (e.g. pump, injector, column, and detector.) For these flow rates and tubing dimensions, it is relatively easy to machine port details to tolerances that will ensure minimal band broadening at tubing interfaces.

A desire to reduce mobile-phase solvent consumption, in part, has motivated a trend towards reducing column inner diameter. Thus, several scales of chromatography are now commonly practiced; these are typically defined as shown in Table 1 (where ID is inner diameter.)

TABLE 1

| | | |
|---|---|---|
| HPLC Scale | Column ID | Typical Flow range |

| | | | | |
|---|---|---|---|---|
| Analytical | 4.7 | mm | 1's | mL/min |
| Microbore | 1-2 | mm | 100's | μL/min |
| Capillary | 300-500 | μm | 10's | μL/min |
| Nano | 50-150 | μm | 100's | nL/min |

Microbore HPLC has often been practiced with equipment similar to that used for analytical scale HPLC, with minor modifications. Aside from requiring the exercise of a small degree of additional care in making fittings, microbore HPLC typically requires an operating skill level similar to that of analytical scale HPLC.

In contrast, Capillary and nano-scale HPLC require relatively significant changes in HPLC components relative to analytical-scale HPLC. Generation of stable mobile-phase flows of less than about 50 μL/min is relatively difficult using standard open-loop reciprocating HPLC pumps, such as those commonly found in analytical and microbore HPLC systems.

For capillary-scale chromatography, stainless-steel tubing is usable for component interconnections, however the inner diameter must typically be less than 0.005 inch (less than about 125 μm.) Care is generally required in the manufacture of fitting terminations to avoid creation of even minute amounts of dead volume.

For nano-scale chromatography, tubing having inner diameters of about 25-50 μm is typically required to interconnect components of an instrument (e.g., to connect a pump to a separation column.) Because stainless-steel tubing is typically unavailable in these dimensions, polyimide-coated fused-silica tubing is typically used. While fused-silica tubing has excellent dimensional tolerances and very clean, non-reactive interior walls, it is fragile and can be difficult to work with. In addition, interconnection ports should be machined to exacting tolerances to prevent even nanoliters of unswept dead volume.

While the primary driver to replace analytical-scale HPLC with microbore-scale HPLC can be a desire for reduced solvent consumption, moving to capillary-scale and nano-scale chromatography, in addition to further reducing solvent consumption, can support improved detection sensitivity for mass spectrometers when, for example, flows of less than about 10 μL/min are used. Moreover, capillary-scale or nano-scale systems are often the only options for the sensitive detection typically required for applications involving small amounts of available sample (e.g., neonatal blood screening.)

In spite of the advantages of capillary-scale and nano-scale chromatography, HPLC users tend to employ microbore-scale and analytical-scale chromatography systems. As described above, these systems typically provide good reliability and relative ease-of-use. In contrast, maintenance of good chromatographic efficiency while operating a capillary-scale or nano-scale chromatographic system requires significant care when plumbing the system (e.g., using tubing to connect pump, injector, column and detector.)

In practice, an operator switching from an analytical/microbore-scale system to a capillary/nano-scale system at times finds that better separation efficiency was achieved with the higher-flow rate (i.e., analytical/microbore-scale) system. This typically occurs due to insufficiency in the operator's knowledge or experience required to achieve low band-spreading tubing interconnections. Moreover, use of smaller inner-diameter tubing at times leads to more frequent plugging of tubing.

Due the relative difficulty typically encountered with capillary-scale HPLC systems and, even more so, with nano-scale HPLC systems, such systems have primarily been used only when necessary, such as for small sample sizes, and when a relatively skilled operator is available. Thus, analytical laboratories tend to possess more analytical-scale and microbore-scale systems than capillary-scale and nano-scale systems, and do not realize the full benefits available from capillary-scale and nano-scale HPLC.

### SUMMARY OF THE INVENTION

The invention arises, in part, from a realization that an integrated high-pressure chemical-separation device, such as an HPLC instrument, is advantageously fabricated, in part, from sintered inorganic particles. Conveniently, in some exemplary embodiments of the invention, an HPLC instrument is fabricated, with various degrees of integration, from laminated co-fired ceramic-based tape. Some embodiments of the invention provide any or all of the following advantages: reduced numbers of valves and/or reduced length and/or numbers of sections of interconnect tubing, easier fabrication, low-cost fabrication, easier operation of capillary-scale and nano-scale LC, reduced dead-volume, reduced size, disposable devices, integrated devices, and high-pressure liquid chromatography in a ceramic-based device. For example, some embodiments of the invention provide nano-scale microfluidic HPLC instruments that offer similar ease-of-use and reliable operation to that of prior analytical-scale or microbore-scale instruments.

Some embodiments of the invention provide advantages over prior microfluidic devices that entail low-pressure operation for, for example, electrophoretic separation or flow-injection analysis. Some of these prior microfluidic devices provide relatively low-pressure operation in microfluidic platforms constructed from glass, silicon, or synthetic polymers. Construction of such low- or no-pressure microfluidic devices typically requires relatively simple interfaces to load samples and run analyses.

In contrast, some embodiments of the invention entail HPLC realized on a microfluidic substrate. Some of these embodiments provide microfluidic-based HPLC systems capable of operation under hydraulic pressures in excess of about 1000 psi, and as high as about 15,000 psi, or higher.

Some embodiments of the invention provide advantages over prior systems in which a separation column is a consumable. A microfluidic-based high-pressure column, according to these embodiments, employ one or more no-fitting interfaces to ensure that low dead-volume is preserved at such interfaces when a user replaces a column. For example, one embodiment includes a substrate that defines a trap column and a separation column connected within the substrate. Some of these embodiments also include some macro-scale fittings, which, however, would rarely be manipulated by typical users.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a flow diagram of a method for fabricating analytical-instrument tubing, in accordance with one embodiment of the invention;

FIG. 1 is a cross-sectional diagram of a portion of a chemical-processing device, in accordance with one embodiment of the invention;

FIG. 2A is a side-view diagram of a portion of an instrument, in accordance with one embodiment of the invention;

FIG. 2B is a cross-sectional diagram of a portion of an instrument, in accordance with one embodiment of the invention;

FIG. 3A is a calculational mesh map of one corner of a conduit model;

FIG. 3B is a graph of maximum sustainable pressure, in accordance with one illustrative model;

FIG. 3C is a graph of maximum sustainable pressure versus width of a conduit, in accordance with one illustrative model;

FIG. 3D is a graph of maximum sustainable pressure versus number of layers, in accordance with one illustrative model;

FIG. 4 is a top-view diagram of chemical-processing unit, in accordance with one embodiment of the invention;

FIG. 5A is a block diagram of a top view of a portion of a ceramic-based device at an intermediate stage of fabrication, in accordance with one embodiment of the invention;

FIG. 5B is a block diagram of a top view of a portion of a ceramic-based device, in accordance with one embodiment of the invention;

FIG. 5C is a block diagram of a side view of a portion of a ceramic-based device at an intermediate stage of fabrication, in accordance with one embodiment of the invention;

FIG. 6A is a block diagram of a side view of a portion a ceramic-based device that incorporates an electrospray interface, in accordance with one embodiment of the invention;

FIG. 6B is a block diagram of a side view of a portion a ceramic-based device that includes a processing-unit, an electrospray interface, and a connector, in accordance with one embodiment of the invention;

FIG. 7 is a block diagram of a side view of a portion of a ceramic-based device, in accordance with one embodiment of the invention;

FIG. 8 is a top view of a diagram of a portion of a ceramic-based chromatographic device, in accordance with one embodiment of the invention;

FIG. 9 is a top view of a diagram of a portion of a ceramic-based device, in accordance with one embodiment of the invention;

FIG. 10 is a graph of temperature of a fluid in a conduit as a function of position in the conduit, in accordance with one illustrative example;

FIG. 11 is a cross-sectional diagram of an EK pump formed in a ceramic substrate, in accordance with one embodiment of the invention;

FIG. 12 is a cross-sectional end-view diagram of an EK ceramic-based pumping apparatus that utilizes a gas-free isolated electrode system, in accordance with one embodiment of the invention;

FIG. 13A is a top view block diagram of a ceramic-based EK pumping flow source, in accordance with one embodiment of the invention;

FIG. 13B is a top view block diagram of a ceramic-based EK pumping flow source, in accordance with one embodiment of the invention;

FIG. 14A is a top view block diagram of a ceramic-based liquid-processing apparatus, in accordance with one embodiment of the invention;

FIG. 14B is a top view block diagram of a ceramic-based liquid-processing apparatus, in accordance with one embodiment of the invention;

FIG. 14C is a top view block diagram of a ceramic-based liquid-processing apparatus, in accordance with one embodiment of the invention;

FIG. 15A is a three-dimensional view of a ceramic-based device, illustrating microfluidic components associated with a patterned layer of a substrate, in accordance with one embodiment of the invention;

FIG. 15B is a three-dimensional view of the ceramic-based device of FIG. 15A, illustrating electronic components associated with a surface of the substrate;

FIG. 16A is a side view block diagram of a portion of a valve portion of a ceramic-based microfluidic system, in accordance with one embodiment of the invention; and

FIG. 16B is a top view block diagram of the portion of the valve portion of FIG. 16A.

### DESCRIPTION

Several embodiments of the invention, some illustrative examples of which are described below, include components formed in part from ceramic particulate materials or entail methods for making devices that are fabricated, at least in part, from such materials. Prior to describing these examples in more detail, some features of fabrication methods generally applicable to numerous embodiments of the invention are described next.

Conveniently, some embodiments utilize unfired material in a tape form (herein referred to occasionally as “green sheet” or “green-sheet tape”) for fabrication of a device. Green-sheet material permits relatively easy, low-cost fabrication of a microfluidic device that supports operation at relatively high pressures, in cooperation with other components, according to some principles of the invention.

Green sheet includes particulate materials in a convenient form for handling and configuring prior to sintering. Green sheet typically includes ceramic particles dispersed in an organic binder. During sintering, the organic binder burns off while the ceramic particles form direct and/or indirect bonds to one another. Two or more sheets of green-sheet tape can be laminated with or without intermediate layers of adhesive. After sintering, a unitary device body is obtained.

The following detailed description of particular green-sheet materials and fabrication steps is intended to be illustrative and not comprehensive. Accordingly, this description should be understood as not limiting fabrication methods of the invention to any particular set of steps or particular materials.

Particle-containing tape includes, for example, ceramic particles cast in an organic binder. In their unfired state, these tapes are flexible and easily machined or otherwise patterned and configured. In various embodiments of the invention, holes, vias, channels, and/or other microfludic features are defined by, for example, machine or laser removal, and/or embossing one or more portions of tape, and/or disposing a fugitive material between tape layers.

One or more layers are stacked, laminated and fired, creating a relatively homogenous rigid substrate having internal microfluidic features. In some embodiments, tape is “co-fired” in the sense that metal conductors and/or other features are printed or otherwise disposed with the tape and co-fired with the tape to include additional components with microfluidic conduits.

Suitable green-sheet material includes composites that include inorganic particles of glass, glass-ceramic, ceramic, or mixtures thereof, dispersed in a polymer binder, and also optionally include additives such as plasticizers and dispersants. Ceramic particles are any suitable ceramic particles, including known particles, such as aluminum oxide or zirconium oxide.

Such devices are fabricated, in some embodiments, from low-temperature and/or high-temperature co-fired ceramics (LTCC, HTCC). Embodiments that include LTCC materials, for example, utilize any suitable LTCC material, including commercially available materials, such as DUPONT™ 951 GREEN TAPE™ low temperature co-fire dielectric tape (available from DuPont Electronic Materials, Research Triangle Park, NC, in thicknesses from about 50 μm to about 250 μm.) Such LTCC material sinters at about 850° C. The relatively low-temperature of sintering permits the use of highly conductive precious-metal thick-film conductors of, for example, gold, silver or their alloys in embodiments that include integrated electrical interconnect.

After lamination and firing, green-sheet material forms a substantially monolithic structure. For some electronic applications, electronic-device processing methods using commercially available ceramic green-sheet material are known to those having ordinary skill in the electronic device arts.

One device fabrication method, according to the invention, utilizes sheets of any suitable thickness, such as commercially available thicknesses of between about 50 μm and about 250 μm. The sheets are cut to a desired size, and one or more green-sheet layers is optionally textured using various techniques to form desired structures, such as vias, channels, or cavities, in the finished multilayered structure.

As mentioned, any suitable technique, including known techniques, are used to texture a green-sheet layer. For example, portions of a green-sheet layer may be punched out to form vias or channels. This operation may be accomplished using any suitable punch, such as a conventional multilayer ceramic punch. Alternatively, features are defined by embossing them into the surface of one or more green sheets using, for example, an embossing plate. Alternatively, texturing is accomplished via etching to remove portions of one or more sheets, such as with a laser tool.

In addition to embossing or removing material to define microfluidic features, a variety of materials are optionally applied to the sheets, for example, in the form of thick-film pastes. These materials provide any of numerous optional features such as: electrical interconnect, resistors, piezoelectric components, and conduits (via use of porous materials and/or fugitive materials that escape during sintering.)

Thick-film pastes typically include a desired material, which may be a metal and/or a dielectric, in the form of a powder dispersed in an organic vehicle, and the pastes are designed to have the viscosity appropriate for the desired deposition technique, such as screen-printing. The organic vehicle includes, for example, resins, solvents, surfactants, and flow-control agents. The thick-film paste also includes, for example, a flux, such as a glass frit, to facilitate sintering. Thick-film technology, as applied to electronic applications, is known to those having ordinary skill in the electronic-device packaging arts.

Porosity of a fired thick-film material is adjusted by, for example, varying an amount of organic material. Similarly, a porosity of a green-sheet layer is optionally varied by changing a proportion of organic binder. Alternatively, porosity is increased by dispersing within an organic vehicle, or an organic binder, another organic phase, such as polymer microspheres, that is not soluble in the organic vehicle.

Electrical interconnect is formed from, for example, thick-film pastes that include metal particles of silver, platinum, palladium, gold, copper, tungsten, nickel, tin, or alloys thereof. Examples of suitable silver pastes are silver conductor composition numbers 7025 and 7713 sold by E. I. Du Pont de Nemours and Company.

In some embodiments, after texturing and deposition of materials, two or more sheets are laminated, with or without intermediate layers of adhesive, such as a room-temperature pressure-sensitive adhesive. Adhesive is applied by any suitable technique, such as conventional coating techniques.

Layers are stacked together to form a multilayered green-sheet structure. Alignment holes are optionally included in the layers to facilitate the stacking process.

The lamination process optionally involves the application of pressure to the stacked layers. For example, a uniaxial pressure of about 1000 to 1500 psi is applied to the stacked green-sheet layers, followed by application of an isostatic pressure of about 3000 to 5000 psi for about 10 to 15 minutes at an elevated temperature, such as 70° C.

In some embodiments, pressures of less than 2500 psi minimize changes in dimensions of defined microfluidic structures. In some embodiments, pressures that are still lower allow formation of larger conduits and other cavities. Some embodiments limit maximum pressures to less than about 1000 psi or less than about 300 psi or less than about 100 psi. Some embodiments, described in more detail below, utilize pressure to provide a desired shape for a conduit.

Firing of the stacked assembly converts the laminated multilayered green-sheet structure from a green state to a sintered state, forming a substantially monolithic multilayered structure. A two-stage process is used, in some cases. In the first stage, binder and/or other organic materials are burned out in a temperature range of, for example, about 250 to 500° C.

In the second stage, sintering of inorganic particles occurs. A sintering temperature is selected in response to a composition of the green sheet. For many types of ceramics, appropriate sintering temperatures range from about 950° C. to about 1600° C. For example, for green-sheet containing aluminum oxide, sintering temperatures between 1400° C. and 1600° C. are often suitable. Other ceramic materials, such as silicon nitride, aluminum nitride, and silicon carbide, may require higher sintering temperatures, such as about 1700° C. to about 2200° C.

Inclusion of glassy particles at times provides a lower sintering temperature. For example, if a green sheet includes glassy particles, a sintering temperature in a range of 750° C. to 950° C. is available. Common glassy particles generally provide sintering temperatures in a range of about 350° C. to 700° C. Finally, metal particles may require sintering temperatures in a range of 550° C. to 1700° C., depending on the metal.

A laminate is fired for any suitable length of time, such as about 4 hours to about 12 hours or more, depending on the material used. A firing process, in some cases, is selected to provide sufficient temperature and duration to decompose polymers and allow for their removal. Before or after firing, the layered sheets may be diced to obtain multiple devices from a single laminated assembly.

As known to one having ordinary skill in the electronic-device packaging arts, sintered green-sheet laminates from commercially available material tend to shrink during burnout by about 0.5 to 1.5% in volume, and tend to shrink during sintering by about 14 to 17% in volume. In some embodiments added materials, such as pastes, are selected to provide compatible processing temperatures and amounts of shrinkage between the different materials present in an unfired stack. Symmetrical disposition of added features is also used in some cases to reduce internal stresses arising from mismatched shrinkage of different materials.

As mentioned above, various embodiments include features that support high-pressure operation. Suitable materials are selected to support a desired pressure level. For example, some commercially available LTCC materials are composed of alumina and glass, while some commercially available HTCC materials are composed mainly of alumina. The latter, depending on processing, have a fracture strength about 1.5 to 2 times greater than the former. Because support for hydraulic pressure increases with fracture strength, increasing approximately linearly with the fracture strength of an underlying sintered material, HTCC materials, as a generality, will provide higher pressure capability (other features being similar) than LTCC materials.

Some embodiments of the invention utilize less common HTCC materials that provide relatively higher fracture strength than the more common HTCC materials, to support higher fluidic pressures. One such class of materials is, for example, the yttria-stabilized zirconia-based class of materials.

While the above-described HTCC materials, in some embodiments, support pressures up to about 10,000 psi, or more, some zirconia-based materials provide a fracture strength of about 3 time the fracture strength of typical LTCC material (as much as about 2 times the fracture strength of some common HTCC materials.) Hence, some embodiments utilizing this material support pressures of up to about 20,000 psi or more. Such material is commercially available from, for example, ESL Electro-Science, King of Prussia, Pa. as product number 42000 yttria-stabilized HTCC tape.

The word “sintering” as used herein refers to elevated-temperature processing of a collection of particles that causes the particles to directly or indirectly bond to one another. The formation of indirect or direct bonds entail, in some cases, diffusive and/or melting processes. For example, in some cases, particles having direct contact form direct bonds as a consequence of diffusion of the particles constituent elements. In some cases, after sintering, particles have indirect contact via an intermediate phase.

The particles are formed from, for example, glassy or crystalline materials, for example, crystalline ceramic materials. An intermediate phase includes, for example, a glassy material. Additional materials at times are included with a collection of particles prior to sintering. For example, additional materials include ceramic particles, glassy particles, metallic particles, and/or organic materials, such as binder materials.

As was described above, many of the ease-of-use and reliability issues in a nano-scale HPLC system arise from the difficulty in making low dead-volume interconnections. A microfluidic-based HPLC system has the potential of avoiding many of these issues. At least some HPLC components are constructed as microfluidic elements, and desirable interconnections are made between these elements via suitable microfluidic channels.

Some illustrative embodiments of the invention are described in more detail in the following. In view of this description, other embodiments and components will be apparent to one having ordinary skill in the compound-analysis arts.

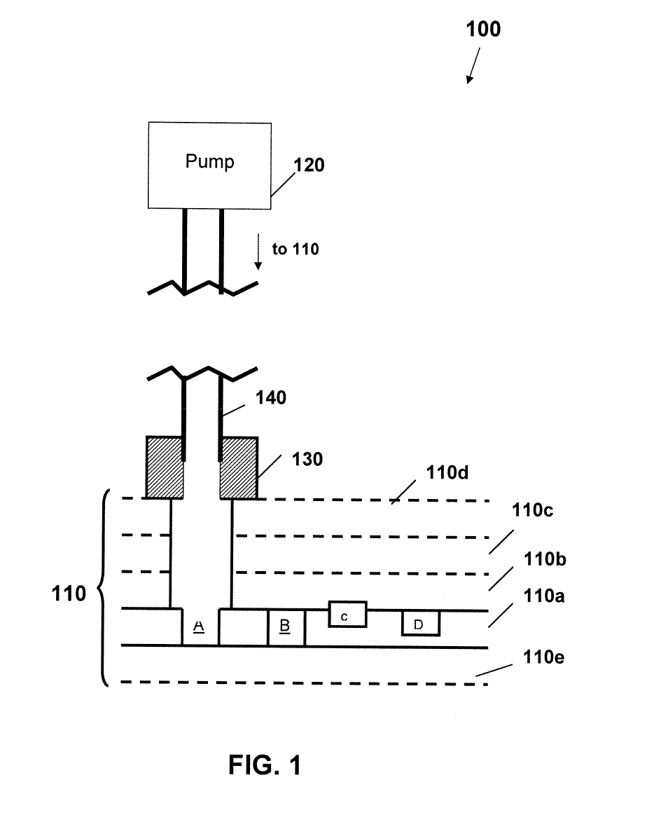

Some basic structural features of some embodiments of the invention are described next, with reference to FIG. 1.

FIG. 1 is a cross-sectional diagram of a portion of a chemical-processing device 100, according to one embodiment of the invention. The device 100 includes a processing unit 110, a high-pressure pump 120, a tube 140 receiving a fluid from the high-pressure pump 120, and a high-pressure connector 130 that attaches the conduit 140 to the processing unit 110.

The processing unit 110 is formed at least in part of sintered inorganic particles, and defines a separation column in fluidic communication with an inlet port of the processing unit 110. In a preferred embodiment, the pump 120 is configured to deliver a liquid including a solvent at a pressure at least sufficient for high-performance liquid chromatography. The high-pressure connector 130 is in physical communication with the inlet port to provide a substantially leak-free connection for the conduit 140 receiving the liquid delivered by the high-pressure pump 120. The device 100 optionally includes additionally components such as pump(s), conduit(s), column(s), electrical component(s), computer(s), etc., as will be recognized by one having ordinary skill in the chemical-processing arts.

The processing unit 110 includes a first layer 110a and optionally includes one or more additional layers 110b, 110c, 110d, 110e. One or more, preferably all, of the layers 110b, 110c, 110d, 110e of the processing unit 110 are preferably derived from ceramic-based green-sheet tape and assembled to form the processing unit 110 in a manner described.

The separation column and other conduits defined by the processing unit 110 optionally extend fully or partially through the thickness of one or more of the layers 110b, 110c, 110d, 110e, as illustrated in FIG. 1 at reference indicia A, B, C, and D (viewed end-on.) Optionally, as described in the above-description of green-sheet processing, the conduits A, B, C, D are defined in unfired material by removing portions of one or more of the layers 110b, 110c, 110d, 110e, by embossing one or more of the layers 110b, 110c, 110d, 110e, or by depositing a fugitive material between any two layers 110b, 110c, 110d, 110e. As illustrated, one of the conduits A is fluidically connected, by the high-pressure connector 130, to the tube 140.

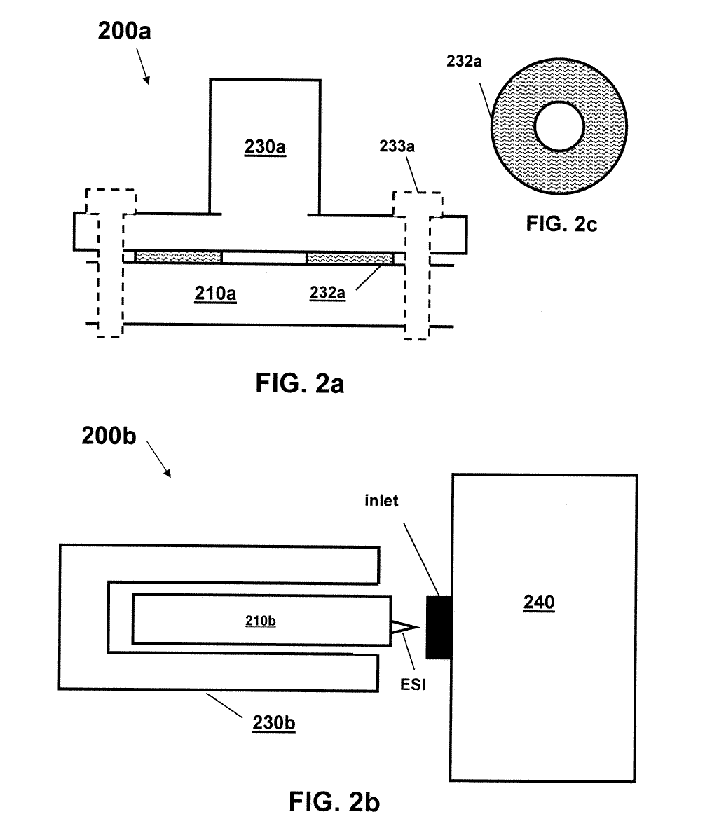

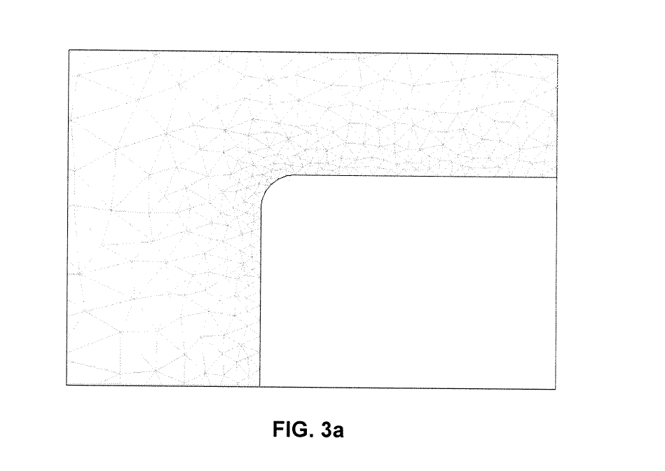

The separation column has any suitable width, preferably less than about 500 μm. For higher-pressure operation, the width is preferably less than about 200 μm. The high-pressure pump 120 and the high-pressure connector 130 are configured for substantially leak-free operation at a pressure greater than about 1 kspi, or greater than about 2 kpsi, or greater than about 5 kpsi, or greater than about 10 kpsi, or greater than about 15 kpsi, or greater than about 20 kpsi. In particular, some preferred embodiments of the invention are capillary and nano-scale HPLC systems that provide advantageous fluidic connections in comparison with some prior high-pressure systems. Some embodiments of suitable connectors that support high-pressure operation are described in more detail with reference to FIGS. 2a and 2b.

FIG. 2a is a side-view diagram of a portion of an instrument 200a. The instrument 200a includes a processing unit 210a, similar to the unit 110, and a connector 230a that optionally is used as the connector 130 of the instrument 100.

The connector 230a includes a housing 231a that is permanently or removably attached directly or indirectly to the processing unit 210a. For example, to attach the housing unit 231a, the connector 230a optionally includes a sealing unit 232a and/or attachments 233a, which also support a high-pressure substantially leak-tight seal between the housing 231a and the processing unit 210a.

The sealing unit 232a includes, for example, an adhesive and/or a gasket. A gasket is formed from any suitable material(s), including known material(s), such as polymide, polyetheretherketone, tetrafluoroethylene, and polydimethylsiloxane, and optionally has, for example, a coating of adhesive to attach the gasket to the processing unit 210a.

A gasket has any suitable shape, such as round, polygonal, or irregular. In one alternative (illustrated in top-view diagram of FIG. 2c), a gasket 232c has a donut shape.

A gasket optionally has an area of less than about 0.05 square inch. A gasket has a gasket factor of at least about 1:1 or, for example, at least about 1.5:1 for better reliability.

The attachments 233a include any suitable mechanical component(s) for attaching the housing 231a to the processing unit 210a. As illustrated, the attachments 233a optionally include bolt assemblies disposed in throughholes defined in the processing unit 210a. The bolt assemblies are adjusted to apply a sufficient pressure, for a selected operating pressure, to provide a substantially leak-free interface between the housing 231a and the processing unit 210a.

The housing 231a has a suitable configuration, optionally including known configurations, for connecting to a tube. For example, the housing 231a optionally includes features similar to known HPLC connectors. For example, in one implementation, the housing 231a includes two threaded metallic components and a polymer ferrule, which, as will be understood by one having ordinary skill in the chromatography arts, serve to provide a fluid-tight connection to a conduit.

FIG. 2b is a cross-sectional diagram of a portion of an instrument 200b. The instrument 200b includes a processing unit 210b, for example, similar to the unit 110, and a fixture 230b. The instrument 200b optionally includes an analytical module 240, such as a mass-spectrometry unit, that provides further analysis of compounds outputted by the processing unit 210b.

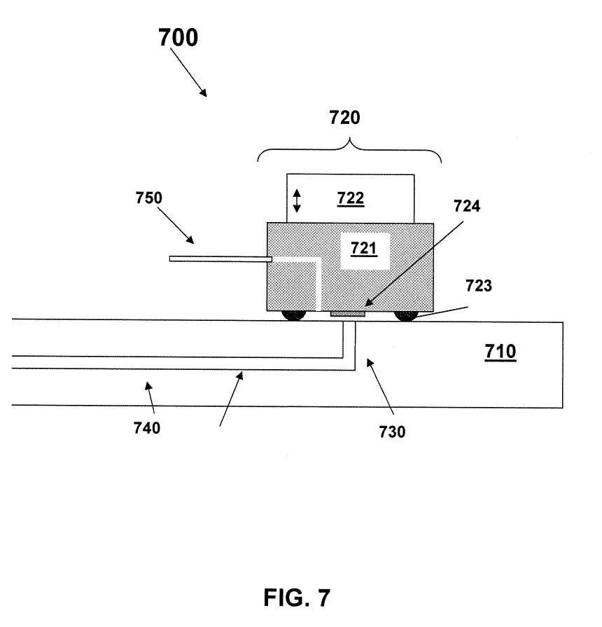

In alternative implementations, the fixture 230b acts as a support unit that, in part, positions the processing unit 210b adjacent to an inlet port of a mass spectrometer. In this implementation, the processing unit 210b optionally includes, for example, an electrospray interface (ESI) that directs separated material into the inlet port of the mass spectrometer. The ESI has any suitable configuration, which optionally includes features of configurations known to one having ordinary skill in the mass-spectrometry arts. Further details regarding embodiments of ESI's are described with reference to FIGS. 7a and 7b.

The fixture 230b, in some alternative implementations, includes one or more hinges and/or one or more springs to facilitate disposition and exchange of processing units 210b. The fixture 230b optionally includes components that interface with the processing unit 210b to provide, for example, fluidic and/or electrical connections to the processing unit 210b.

For example, in one alternative, the fixture 230b provides a fluidic connection to an inlet port of the processing unit 210b in a manner, for example, similar to the connector 230a.

In view of the above description, other configurations for the fixture 230b will be apparent to one having ordinary skill. For example, alternative fixtures support two or more processing units, and some instruments include two or more fixtures that support two or more processing units.

As indicated above, some preferred embodiments of the invention entail microfluidic ceramic-based instruments that support relatively high fluidic-pressures. In some embodiments of the invention, a separation column and/or other conduits are configured to sustain selected operating pressures, such as those required to perform HPLC. Column-configuration features of interest include, for example, dimensions and/or shapes that provide greater resistance to fracture failure under pressure loading or repeated pressure loading.

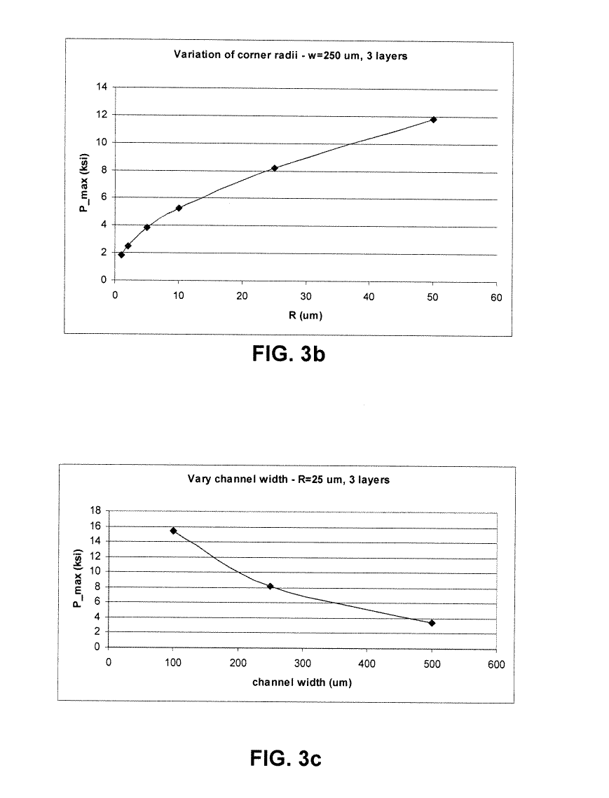

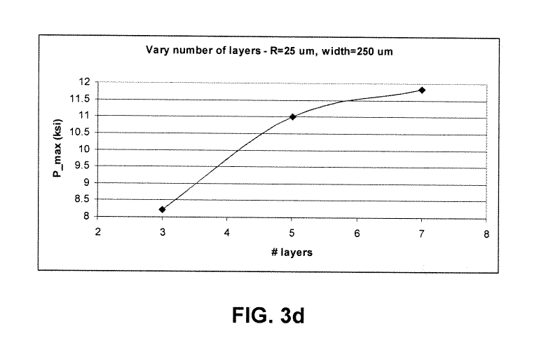

Conduit configurations, such as height, width, aspect ratio, and/or radius of curvature are selected, for example, via empirical and/or theoretical considerations. For example, with reference to FIGS. 3a through 3d, stresses in a device are estimated via model calculations to illustrate selection of some exemplary configurations. These calculations should be understood as merely being illustrative and not limiting in the selection of configurations nor an indication of any particular level of accuracy or completeness of the illustrated example.

In the present example, a model LTCC-based conduit is assumed to be deformed by an internal pressure of 50 MPa (7,250 psi.) A 2-dimensional finite-element calculation is utilized to illustrate the behavior of a conduit under various conditions of pressure and configuration. Plain strain is assumed. The right and left sides of a calculational domain were fixed (i.e., no deflection for zero-pressure condition.)

FIG. 3a illustrates a calculational mesh map of one corner of a conduit model (denser portions of the mesh correspond to regions of ceramic material having higher stress.) The map illustrates the stress concentrator effect associated with the corners of the conduit and their radii of curvature.

The hypothetical LTCC material was assumed to have isotropic elasticity with values of Young's modulus of 152 Gpa, a Poisson's ratio of 0.17, and a fracture strength of 320 MPa (corresponding approximately to properties of fired DuPont™ 951 Green Tape™ low temperature cofire dielectric tape, available from DuPont Electronic Materials, Research Triangle Park, NC.)

The model, of the present example, has three layers, each 150 μm thick, and a channel of 250 μm in width (the channel has the height of one layer, i.e., 250 μm.)

For purely illustrative purposes, a Von Mises stress-type calculation (typically applied to ductile rather than brittle materials, as in the present example) is utilized to determine a maximum value of stress, σₘₐₓ, present in the ceramic. In the example of FIG. 3a (i.e., pressure in the channel of 50 MPa), σₘₐₓ is approximately 282.2 MPa. The maximum deformation predicted by this calculation is less than 0.2 μm.

Assuming a linear behavior of the model ceramic materials in response to an increasing applied pressure (i.e., increasing pressure applied to the walls of the conduit), a maximum pressure, Pₘₐₓ, at which fracture occurs can be obtained. Pₘₐₓ is obtained, for example, by determining at what conduit pressure the maximum stress in the ceramic, σₘₐₓ, is equal to the fracture strength of the ceramic material, in this case 320 Mpa.

The maximum sustainable pressure, Pₘₐₓ, will generally be a factor of a radius of curvature of a conduit wall. For example, the illustrative model of FIG. 3a has an approximate rectangular shape with four rounded corners each having a radius of curvature of approximately 25 μm. As described below with reference to FIG. 3b, Pₘₐₓ for the model of FIG. 3a is estimated to be approximately 8,200 psi.

FIG. 3b is a graph of maximum sustainable pressure, Pₘₐₓ, versus magnitude of a corner radius. Pₘₐₓ is approximately 2,000 psi when the corner has a radius of 1 μm. More rounded corners, i.e., having larger radii, generally provide less stress concentration and, thus, lower peak stresses for a given applied hydraulic pressure, and therefore provide higher acceptable applied pressures. For example, radii of 50 μm provide a Pₘₐₓ of approximately 12,000 psi. Again, the specific values described here are intended for illustrative, qualitative purposes.

FIG. 3c is a graph of maximum sustainable pressure versus width of a conduit. In this example, a channel width is varied from 100 to 500 μm. All corners have a radius of 25 μm. The graph indicates that narrower channels, given the fixed height of the conduit, provide higher acceptable pressures.

FIG. 3d is a graph of maximum sustainable pressure versus number of layers. That is, for this calculation, the number of layers is permitted to vary. In this example, all layers are again 150 μm thick, the channel is again 250 μm wide, and, as for FIG. 3a, the corner radii are 25 μm.

As illustrated by the graph, increasing the number of layers from 3 to 5 provides an increase of the maximum pressure of approximately 25%. Increasing the number of layers from 5 to 7 layers improves Pₘₐₓ by less than 10%. Thus, in this example situation, one may reasonably choose to utilize 5 layers of material to obtain a balance between reducing number of layers and increasing maximum sustainable pressure, if so desired.

The above example provides some guidance in some situations regarding selection of device and channel configurations. Thus, in some embodiments, a device based on LTCC materials supports operating pressures greater than about 5,000 psi for channel widths less than about 300 μm.

In some embodiments, corner radii, where present, are preferably greater than about 5 μm, more preferably greater than about 25 μm, and still more preferably greater than about 50 μm or greater, depending on desired ultimate operating pressure. A processing unit, in some embodiments, has a thickness that is in a range of about 3 to about 7 times a height of a separation column.

In some embodiments, fabrication steps support production of corners having desired radii magnitudes. Any suitable technique to produce a desired amount of rounding, including known techniques, is useable. For example, an embossing fixture having a desired degree of rounding of relatively sharp features is usable to define corner radii and/or selection of a level of pressure applied to a green-sheet stack may help to define corner radii.

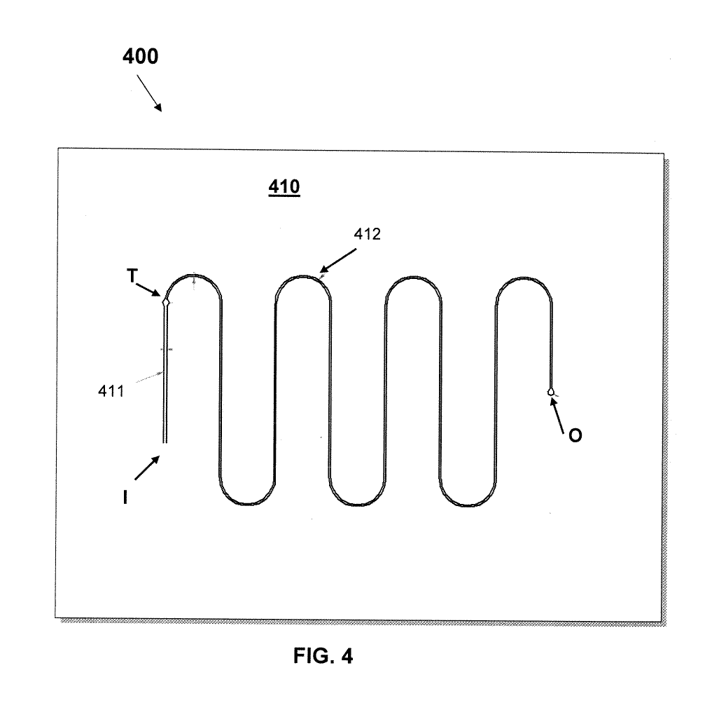

Next, some more detailed alternative illustrative embodiments of devices and fabrication methods of the invention are described with reference to FIGS. 4 through 11.

FIG. 4 is a top-view diagram of chemical-processing unit 400, according to one embodiment of the invention. The unit 400 includes a ceramic-based substrate 410 that defines a trap column 411, a separation column 412, and fluidic ports I, O, T including a trap-column inlet port I, a separation column outlet port O, and a trap-column outlet port T. The trap-column inlet port I provides an inlet to the trap column 411 for fluid from, for example, an injector and a pump. The trap-column outlet port T provides an outlet for the trap column 411. The separation-column outlet port O provides an output for an eluent exiting from the separation column 412.

In one illustrative implementation, the chemical-processing unit 400 includes a three-layer LTCC substrate. The bottom layer is a blank layer, the middle layer includes the trap and separation columns, and the top layer has three via holes aligned with inlets and outlets of the trap column and the separation column, i.e., corresponding to the fluidic ports I, O, T of FIG. 4.

In this implementation, the separation column has a serpentine configuration and a length of approximately 10 cm and a width of approximately 100 μm. The trap column has a length of approximately 1 cm and a width of approximately 180 μm. Generally, a serpentine or other non-linear column configuration permits a size reduction of a ceramic substrate for a given column length relative to a substrate or tube defining a substantially linear column.

A high-pressure fluidic connector is sealed to the trap-column inlet port via, for example, glue or a clamping device. Similar connections are made to the separation column outlet port and to the trap-column outlet port (a trap-valve port.)

The separation column was slurry packed by attaching a fused-silica capillary to the outlet-port connector of the separation column; the capillary had a glass particle frit to trap column-packing particles as the slurry flowed through the separation column and out through the capillary. A dilution level of the packing slurry was empirically selected to provide good packing of the entire separation column. A separation column is optionally flushed and re-packed until a desired packing is obtained to, for example, obtain a desired chromatographic efficiency.

The chemical processing unit 400 is applicable, for example, to nano-scale HPLC with flow rates of less than 500 mL/min. As will be understood by one having ordinary skill in the chromatography arts, a large volume sample is loadable onto the trap column 411 at a flow rate of, for example, 5-20 uL/min. Once the sample has been loaded onto the trap column 411, the trap valve is closed and the solvent gradient is initiated, eluting the sample off the trap column 411 onto the separation column 412 for analysis.

The unit 400 reduces the number of tubing connections found in some prior nano-scale systems. The unit 400, in some alternatives, it used as a consumable due, in part, to its relatively low manufacturing cost.

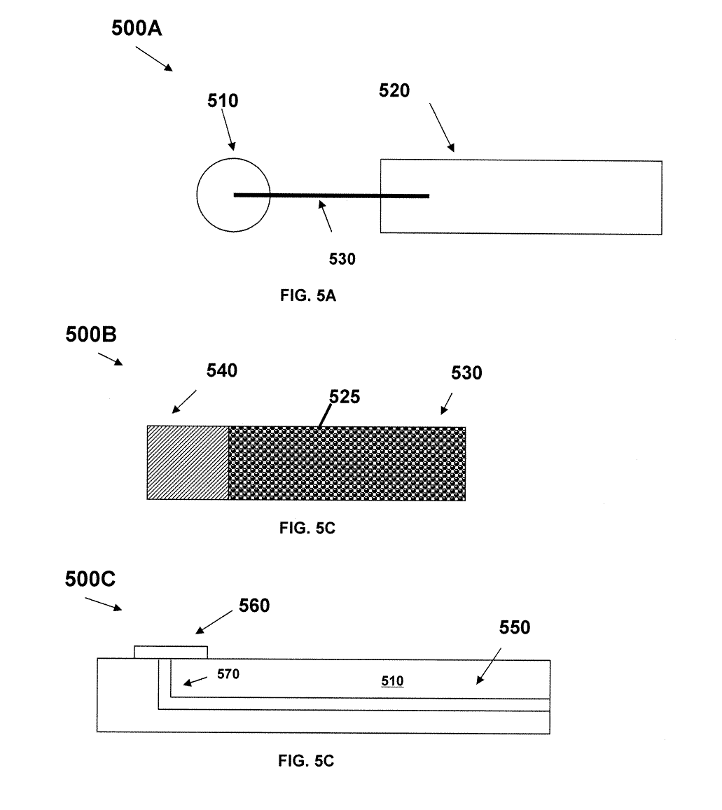

Referring next to FIGS. 5a, 5b, 5c, some embodiments of the invention entail methods for packing conduits in ceramic-based chromatographic devices. These embodiments include separation columns packed with, in some cases, spherical silica particles having diameters in a range of about 1-5 um. The silica material is optionally derivatized with a variety of functional moieties to vary retention behavior.

Some of these embodiments make use of frits or other features to assist trapping of particles in a conduit, such as one or more separation columns. As described below, temporary and/or permanent structures disposed internally and/or externally to a substrate are used to trap particles, in some embodiments.

Some prior column packing techniques are not well suited to some LTCC/HTCC-based nano- or capillary-scale chromatographic systems, according to some embodiments of the invention. For example, some prior high-temperature sintering and chemical bonding methods for frit creation require relatively easy access to the fritted area (i.e., to apply localized heating or deposition of chemical bonding agents.) Such easy access is not available in some embodiments.

FIG. 5a is a block diagram of a top view of a portion of a ceramic-based device 500a at an intermediate stage of fabrication, according to one illustrative embodiment of the invention. The device 500a, at the illustrated intermediate stage of fabrication, includes a separation column 520, a via conduit 510 adjacent to the column 520, and a conduit-defining component 530 disposed between an end of the column 520 and the via 510. The conduit-defining component 530 includes a sacrificial/fugitive material such as carbon-containing material.

The conduit-defining component 530 is, for example, a fine carbon or polymer fiber (e.g., having a diameter of approximately 10 μm.) During firing, the fugitive material burns away (or otherwise gains mobility) leaving a relatively narrow conduit connecting the separation column to the via conduit. The narrow conduit serves as a frit for trapping particles in the column during a later stage of fabrication of the device. The dimensions of the conduit-defining component 530 are selected to define the desired dimensions of the conduit.

In an alternative embodiment, the conduit-defining component 530 is a paste, which is deposited, for example, via screen printing. The paste includes a sacrificial component and, optionally, includes additional materials. The additional materials include, for example, particles formed of a glassy material, a ceramic material, and/or a metallic material.

In an alternative embodiment, a narrow conduit is defined prior to lamination by, for example, removal of material or embossing, as described above.

Although particles with diameters of less than approximately 5 μm are preferred for some embodiments, in some cases particles are adequately trapped by a transition zone between two conduits having diameters both greater than 5 μm: for example, a transition from a 75-150 μm diameter separation column to a 10 μm diameter conduit.

FIG. 5b is a block diagram of a top view of a portion of a ceramic-based device 500b, according to one illustrative embodiment of the invention. The device 500b includes a separation column 525, a porous plug 540 disposed in the column 525, and packed particles 530 disposed in the column 525 adjacent to the plug 540. The porous plug 540 acts as a frit during packing of the column 525.

The porous plug 540 is fabricated via any suitable method, including known methods and methods described above. For example, the porous plug 540 originates from a paste deposited in one end of the separation column 525. The paste optionally includes material that becomes fixed via sintering and/or a chemical-bonding process.

FIG. 5c is a block diagram of a side view of a portion of a ceramic-based device 500c at an intermediate stage of fabrication, according to another illustrative embodiment of the invention. The device 500c includes a substrate 510 defining a separation column 550 and a via conduit 570 connecting an end of the column 550 to an outlet port, and a frit 560 disposed to block the outlet port.

The frit 560 includes any suitable material, including known materials. For example the frit is formed of filter paper, for example, an oriented filter paper that permits fluid flow in substantially a single direction.

The frit 560 is permanently or removably attached to the substrate 510. The frit is attached to the substrate 510 via any suitable mechanism. For example, the frit 560 is optionally glued and/or clipped to the substrate 510.

After packing of the column 550, the outlet port is optionally sealed with or without removal of the frit 560. For example the port and/or frit 560 is optionally sealed with PDMS.

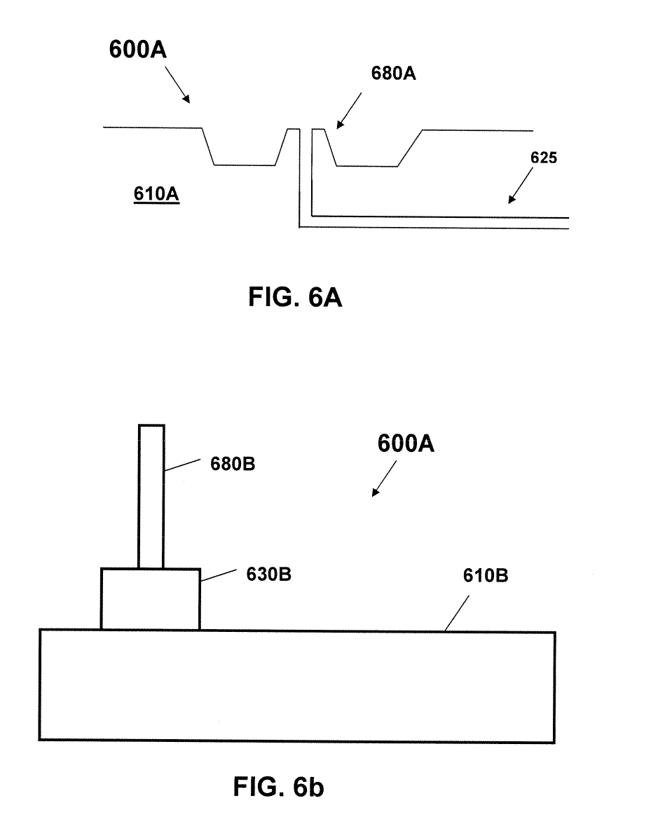

Next referring to FIGS. 6a and 6b, some embodiments of the invention involve electrospray interfaces for mass spectrometry. In some embodiments of the invention, such interfaces are an integral part of a ceramic-based substrate or are attached to a ceramic-based substrate. Some of these embodiments include replaceable electrospray tips. Some embodiments include two or more tips, such as an array of tips.

FIG. 6a is a block diagram of a side view of a portion a ceramic-based device 600a that incorporates an electrospray interface 680a. The device 600a includes a ceramic-based substrate 610a that defines a separation column (not shown) and a conduit 625 connecting an exit of the separation column to the interface 680a. The interface 680a is an integrally formed portion of the substrate 610a.

The interface 680a is formed, for example, in an unfired layer(s) via any suitable technique, including known techniques. For example, a portion of unfired material is removed from around an outlet conduit to form a desired emitter-tip shape. The outlet conduit extends, for example, from an edge of the substrate 610a, parallel to the plane of the substrate 610a, or extends from a surface of the substrate 610a, perpendicular to the plane of the substrate 610a. Other embodiments have emitter tips that extend at non-parallel and non-perpendicular orientations. Unfired material is removed, for example, through use of an eximer laser and/or other methods described above.

FIG. 6b is a block diagram of a side view of a portion a ceramic-based device 600b that includes a processing-unit 610b, an electrospray interface 680b, and a connector 630b. The electrospray interface 680b is permanently attached or removably attached to the substrate 610b. For example, a connector similar one described above with reference to FIG. 2a is usable to removably or permanently attach the interface 680b. The interface 680b is any suitable electrospray interface. For example, the interface 680b optionally has a configuration that is similar to that of electrospray interfaces known to one having ordinary skill in the liquid-chromatography/mass-spectrometry interface arts.

Nano-scale HPLC components of some embodiments of the invention are preferably coupled to a mass spectrometer. A typical mass spectrometer is a concentration-sensitive detection technique that typically improves in sensitivity when flows of less than approximately 10 μL/min are used. While UV and fluorescence detection are major detection methods for analytical and microbore-scale chromatography, it is typically difficult to construct an optical detection flow cell with a low enough volume to prevent band broadening at flow rates of less than approximately 1 μL/min.

The embodiments described above with respect to FIGS. 6a and 6b are optionally used with the embodiment of FIG. 2b.

FIG. 7 is a block diagram of a side view of a portion of a ceramic-based device 700, according to one illustrative embodiment of the invention. The device 700 (similar to the embodiment illustrated in FIG. 4) includes a process-unit substrate 710 that defines a separation column and a trap column (not shown,) a fluidic via 730 leading to a vent port, and a channel 740 connecting the via 730 to the trap column. The device 700 also includes a trap valve 720 in communication with the outlet port of the fluidic via 730.

The valve 720 includes a housing 721, a compliant member 723 that is directly or indirectly mounted on the housing 721, and an actuator 722 that is directly or indirectly mounted on the housing 721. The housing 721 defines a fluidic channel having a vent port 750 and providing a pathway for a fluid flow entering and exiting the valve 720. The valve 720 is disposed adjacent to the outlet of the fluidic via 730.

The valve 720 has opened and closed states. In the closed state, the housing of the valve 720 or an optional component attached thereto blocks the outlet via port. For example, as illustrated, the valve 720 optionally includes a sealing component 724 that presses over and seals the outlet port when the valve 720 is in the closed state. When in the opened state, the compliant member 723 substantially prevent fluid from leaking away from the valve 720 rather than exiting, as desired, through the valve conduit.

In association with the variable valve state, the position of the housing 721 relative to the substrate 710 is adjustable in response to the actuator 722. As illustrated, the valve 720 is in an opened state

The compliant member 723 preferably has an elastic property that permits it to recoverably deform and to provide a seal in spite of at least some particle(s) lodging between the compliant member 723 and the substrate 710.

The compliant member 723 has a circular configuration. In alternative embodiments, a compliant member has alternative configurations, for example, square, rectangular, or a more general shape. Moreover, a compliant member may include two or more component parts. As will be understood by one of ordinary skill, a compliant member may be, for example, an O-ring or a gasket.

At least a portion of the compliant member 723 includes a suitable compliant material(s), including, for example, a known compliant material. For example, an O-ring is suitably made from, for example, nitrile, silicone, fluorocarbon, fluorosilicone, ethylene propylene, neoprene, or polyurethane. In some embodiments, a compliant material is chosen for biocompatibility.

The sealing component 724 is formed of any material that suitably provides a fluidic seal when in contact with the via outlet port. The material is optionally chosen for biocompatibility and/or high-pressure performance. The sealing component, for example, provides a substantially leak-free seal at pressures up to about 1 kpsi, to about 2 kpsi, to about 10 kpsi, to about 15 kpsi, or higher.

The actuator 722 has any suitable configuration that permits controllable positioning of the housing 721 relative to the substrate 720. For the example, the actuator 722 optionally includes a piezo-electric material whose thickness varies via application of an electrical voltage. A piezo-electric actuator includes any suitable piezo-electric materials, including known materials.

Thus, in one example, expansion of a piezo-electric actuator leads to blocking of the outlet port, creating a high-pressure seal. Contraction of the piezo-electric actuator opens the high-pressure seal, allowing fluid to flow out of the port and through the valve conduit. A relatively low-pressure compliant member 723 ensures that fluid exiting the via port is directed out of a vent port of the valve 720.

The trap valve 720 controls diversion of flow to waste, thus enabling samples to be loaded onto the trap column at high flow rates. When the trap valve 720 is closed, flow is directed through the separation column.

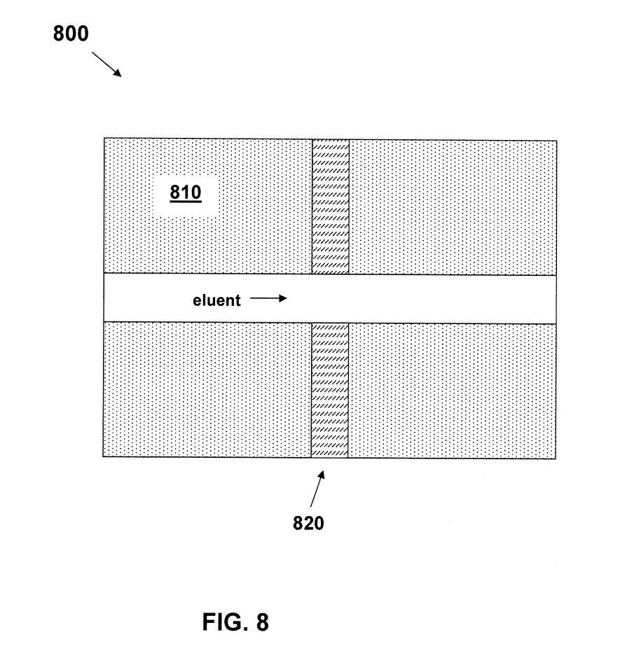

FIG. 8 is a top view of a diagram of a portion of a ceramic-based chromatographic device 800, according to one embodiment of the invention. The device 800 includes a substrate 810, which defines a fluidic channel, and a waveguide 820. The waveguide 820 supports light-based analyses of fluid flowing through the channel, as will be understood by one having ordinary skill in the chromatography arts.

At least portions of the waveguide 820 are disposed in the substrate 810. The waveguide 820 includes any suitable material. The waveguide 820 includes, for example, optical fibers. The channel is formable by any of the above-described techniques.

During fabrication, waveguide material, such as an optical fiber, is disposed between layers of the substrate 810. As an alternative, for example, waveguide channels are formed in a green sheet and then filled with a material having a suitable index of refraction. A suitable index of refraction is, for example, greater than an index of refraction of the surrounding material.

The waveguide 820, in some embodiments, is defined by exposing a light-sensitive material to a pattern of light. For example, light is used to selectively polymerize monomers in a light-sensitive material, so that the resulting photopolymerized regions have an index of refraction that is higher than the surrounding regions. In this way, a pattern of light can be used to define an optical waveguide pattern in polymeric, i.e., plastic materials. Such waveguide-forming materials include, for example, acrylate and methacrylate monomers in a polymer binder and optionally include initiators and other constituents. Some waveguide-forming materials are commercially available from Polymer Photonics, Inc., Kennett Square, Pa.

The device 800 optionally includes light emitters and/or light detectors located in, on and/or off of the substrate 810. A detector includes, for example, a multi-channel detector, such as a charge-coupled device (CCD) or a photodiode array. The waveguide 820 thus supports, for example, light absorption and/or emission spectroscopy, as will be understood by one having ordinary skill in the chromatographic arts. In one alternative, excitation radiation is applied to the channel via one section of the waveguide 820 and fluorescence radiation is received by another section of the waveguide 820.

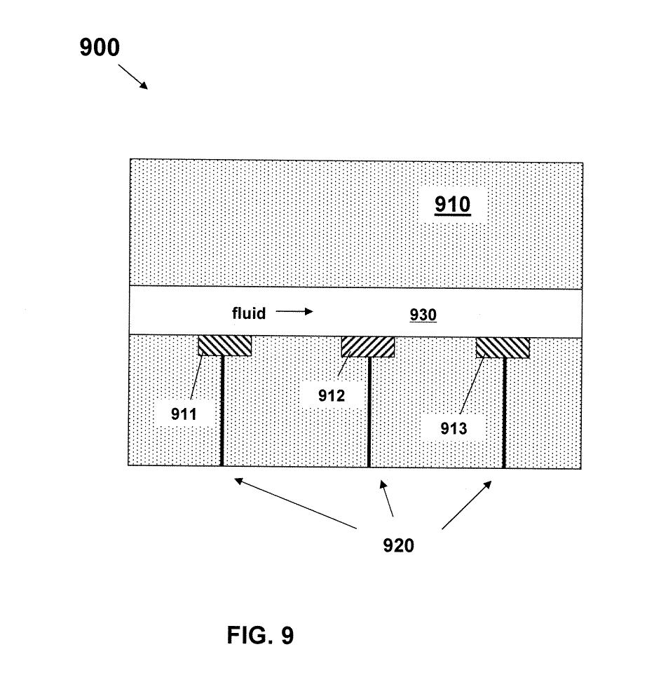

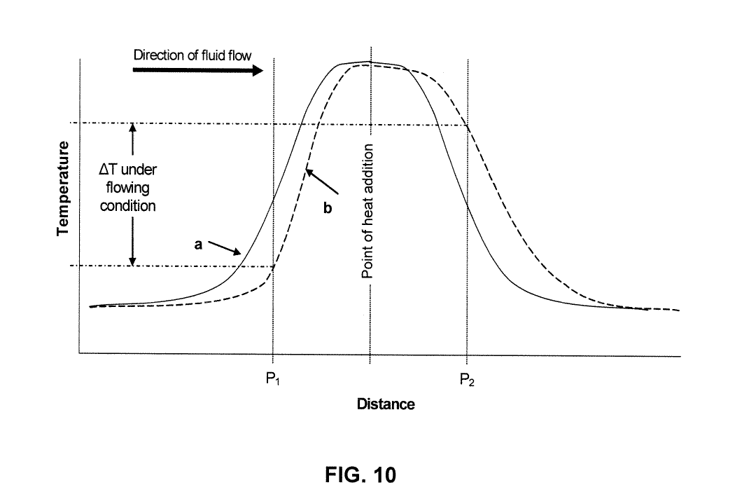

Next referring to FIGS. 9 and 10, flow-control features of some embodiment of the invention are described.

FIG. 9 is a top view of a diagram of a portion of a ceramic-based device 900, according to one embodiment of the invention. The device 900 includes a substrate 910, which defines a fluidic channel 930, flow-sensor components 911, 912, 913 of a thermal-based flow sensor, and electrical interconnect 920 providing electrically conductive paths to the components 911, 912, 913. The thermal-based flow sensor provides suitably accurate measures of flow rates less than 20 μL/min. The flow sensor measures the flow delivered by one or more pumps and the pump is responsively controlled in a manner to obtain a desired flow rate.

As an example, the device 900 supports nano-scale chromatography, i.e., with flow rates, for example, of less than approximately 5 μL/min. Some typical reciprocating-plunger pumping technology used in available analytical systems are not reliable at such low flow rates. Normal seal and check-valve leakage and compression of the fluid during pressurization are typically insignificant in normal-scale HPLC, though cause significant flow errors at nano-scale flow rates. The thermal-based flow sensor supports correction of such errors.

The component 912 includes a heat generator, while the other two components 911, 913 include temperature sensors, which are optionally any suitable temperature sensors. Any of the components are in contact with a fluid in the channel 930 or separated by a ceramic portion of the substrate 910 and/or separated by some additional material, for example, a low thermal conductivity material, such as a glass or a polymer.

The heat generator includes, for example, any suitable known resistive material that increases in temperature in response to an electrical current flowing through the material.

The thermal-based flow sensor operates, for example, as illustrate by FIG. 10. FIG. 10 is a graph of temperature of a fluid in a conduit as a function of position in the conduit. A discrete thermal plug is introduced into the fluid at the indicated position. The introduced heat disperses in both the upstream and downstream directions (i.e. due to fluid movement and/or thermal diffusion.)

If a discrete section of a non-moving fluid in the channel is continuously heated, a temperature profile similar to curve a in FIG. 10 develops. The shape of this temperature profile will depend upon the amount of heat added to the fluid and the upstream and downstream temperatures of the fluid.

Assuming identical upstream and downstream fluid temperatures, under this zero-flow condition, fluid temperatures measured at P1 and P2 will be equal because thermal diffusion is equal in both directions. If the fluid in the channel is permitted to flow, the fluid temperatures at P1 and P2 will now also depend upon the rate of fluid flux and the resulting heat convection. As fluid begins to flow past the heated zone, a temperature profile similar to curve b in FIG. 10 develops because, in addition to the symmetrical diffusion of the heat, asymmetrical convection of the heated fluid occurs in the direction of the fluid flow. Therefore, under flowing conditions, fluid temperatures measured at P1 and P2 are different.

Temperature measurements made at P1 and P2 are sampled and, for example, subtracted and amplified electronically in situ to allow a high degree of common-mode noise rejection, which allows discrimination of extremely small upstream and downstream temperature differences. In addition, by appropriate placement of the temperature sensors, which measures temperatures at P1 and P2, and/or changing the amount of heat added to the flowing fluid, temperature measurements can be made at inflection points along the temperature profile to maximize the upstream/downstream ΔT response to flow rate change.

An alternative or complementary flow control mechanism entails a variable fluidic-resistance element in series with a pump and a flow sensor. A thermally-controlled variable restriction element (TCVRE) may be implemented via heating/cooling using a Peltier element, for example.

Some embodiments of the invention, as indicated above, include electronic devices, such as resistors, embedded in a multilayer device. Resistors, for example, are employable in microfluidic channels as heater elements and/or temperature sensors, as usable in, for example, some flow sensors. Thermally-sensitive thick-film resistive elements that are commercially available for electronic LTCC applications, for example, are suitable for use in some embodiments of the invention.

Some embodiments of the invention include pre- and/or post-column split-flow control features using ceramic-based flow sensors and/or thermally-controlled variable restrictors. Some embodiments include a pressure sensor based on a piezoresistive material. A suitable co-fireable piezoresistive paste is, for example, 3414 series paste (available from Electro-Science Lab, King of Prussia, Pa.)

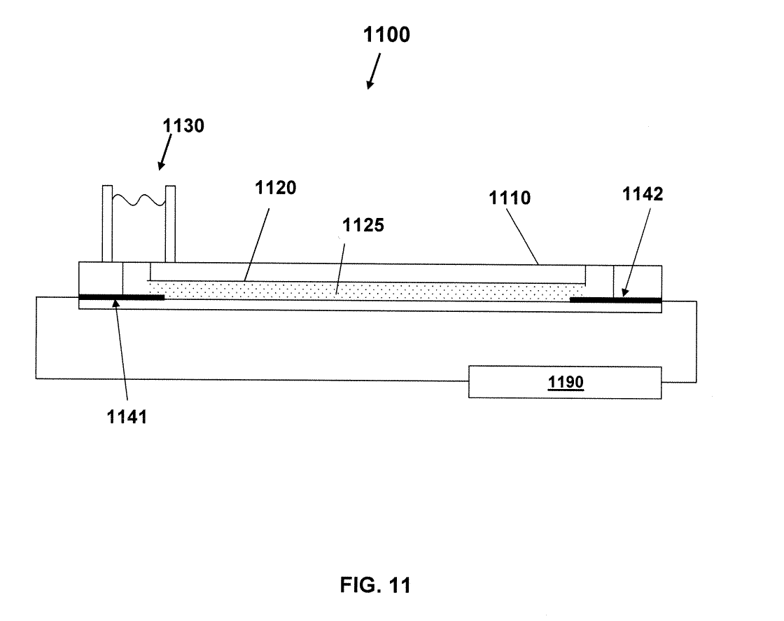

Next referring to FIG. 11, some embodiments of the invention include an electrokinetic (EK) pump formed from ceramic materials, such as the above-described LTCC and/or HTCC materials. Some embodiments of the invention include external EK pump(s) and/or integral EK pump(s) formed in a ceramic substrate. Some embodiments include an integrated EK-based LTCC/HTCC HPLC system (e.g. pump, flow controller, injector, and column.) In some embodiments, an EK pump is produced by forming and packing a channel in similar manner to those described above, with particles or monoliths appropriate to EK functioning.

FIG. 11 is a cross-sectional diagram of an EK pump 1100 formed in a ceramic substrate, in accordance with one embodiment of the invention. The pump 1100 includes a substrate 1110 defining a channel 1120, a porous pumping medium 1125 in the channel 1110, electrodes 1141, 1142 in electrical contact with either end of the porous pumping medium 1125, a power supply 1190 connected to the electrodes 1141, 1142, and a fluid reservoir 1120 adjacent to an inlet port of the channel 1120. The pump 1100 provides pressures of greater than 1 kpsi or greater than 2 kpsi or greater than 5 kpsi or greater than 10 kpsi or greater, as desired. The pressure is controllable in response to a voltage and/or current applied by the power supply 1190.

The electrodes 1141, 1142 and/or the porous pumping medium 1125 are optionally formed though use of, for example, the above-described thick-film techniques. The electrodes 1141, 1142 are optionally solid or porous, as desired, for example, depending on disposition relative to the porous material 1125.

Any suitable materials, including known materials, are used for thick-film processing of the electrodes 1141, 1142 and the porous pumping medium 1125. Platinum thick-films, for example, are suitable to form electrodes, or porous platinum thick films cast in channels are optionally used as high-capacity flow-through electrodes. A non-porous ion-transport medium, such as NAFION® sulfonated tetrafluorethylene copolymer (available from DuPont Wilmington, Del.,) is optionally used, for example, via casting in channels to create fluid-impervious, gas-free electrode systems. See, for example, US Patent Publication 2005/0254967 to Evans and U.S. Pat. No. 7,094,326 to Crocker.

The porous pumping medium 1125 is charged via the power supply to generate pressure and flow via electroosmosis. The porous material 1125 is formed in any suitable manner. For example, some suitable materials include LTCC materials known from fuel-cell use, such as porous ceramic-based electrodes.

The power supply 1190 is any suitable power supply, including known supplies, that provides voltage and/or current control to control flow rate and/or pressure. An apparatus, according to some principles of the invention, optionally includes both EK pump(s) and flow control components. For example, an apparatus includes on-substrate flow-control electronics such as thick-film metallization to support soldering of electronic components to provide analog and/or digital controller circuitry. Alternatively, flow-control electronics are included separately from a ceramic-based substrate.

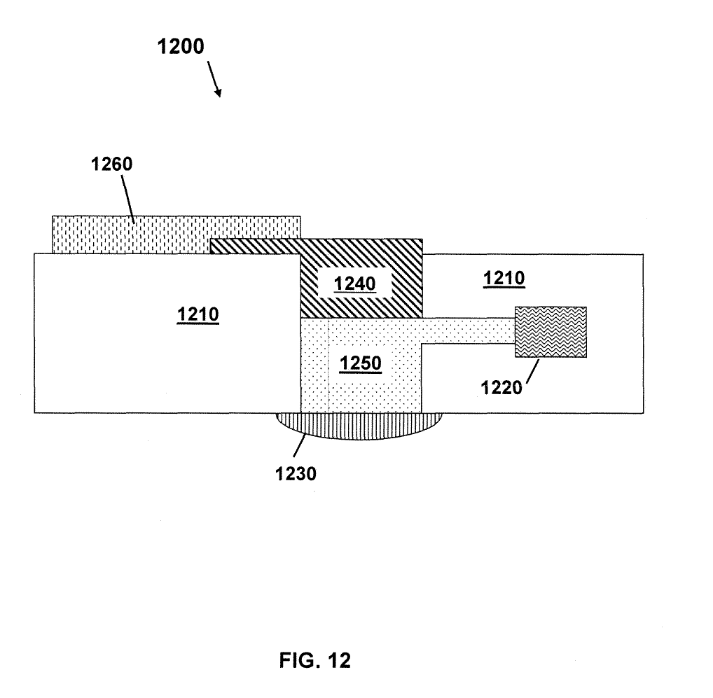

Some EK pumps, according to some principles of the invention, utilize a gas-free electrode(s), for example, a known gas-free electrode, which is substantially free of bubble generation that potentially interferes with the flow of a fluid. For example, FIG. 12 is a cross-sectional end-view diagram of an EK ceramic-based pumping apparatus 1200 that utilizes a gas-free isolated electrode system. The apparatus 1200 includes a ceramic-based substrate 1210, a porous electrode 1240 (also referred to herein as a gas diffusion electrode) formed in a via in the substrate 1210, a conductor connection 1260 in contact with the porous electrode 1240, a porous pump material in an EK-pump channel 1220 defined in the substrate 1210, a non-porous dielectric material 1250 in a channel in the substrate 1210 and in contact with the porous pump material 1220, and an optional non-porous plug 1230 to cap the exposed dielectric material 1250.

The apparatus 1200 is fabricated in any suitable manner. For example, an LTCC or HTCC-based green structure is formed with cavities to accommodate the EK pump channel 1220, the porous pumping medium 1125, and the dielectric material 1250.

Prior to firing, a via, defined to contain portions of both the electrode 1240 and the dielectric material 1250, is partially filled with a porous Pt electrode thick-film material (to form the electrode 1240 by sintering); similarly, a surface thick-film conductor trace (to form the conductor connection 1260) is deposited in contact with the porous Pt via fill.

After firing, the remaining unfilled portion of the via and a channel leading from the via to the EK pump channel 1220 is filled with a non-porous dielectric material such as sulfonated tetrafluorethylene copolymer. Optionally, the exposed dielectric material 1250 is capped. For example, a low curing temperature non-porous plug 1230 (i.e., a typical 2-part epoxy adhesive) is used to cap the exposed via 1250 to prevent extrusion or contamination of the non-porous dielectric material 1250.

The above-described electrode system allows ion transport between the dry conductor 1260 connected to the high-voltage power supply and the pumping fluid while preventing fluid transport between the high-pressure EK pumping fluid and the ambient-pressure exterior of the substrate 1210.

In view of the above description, one of ordinary skill will recognize that some embodiments of EK pumps are optionally configured as pressure sources. Some of these embodiments include a flow sensor and a flow-feedback control system; some of these embodiments provide a suitable flow source.

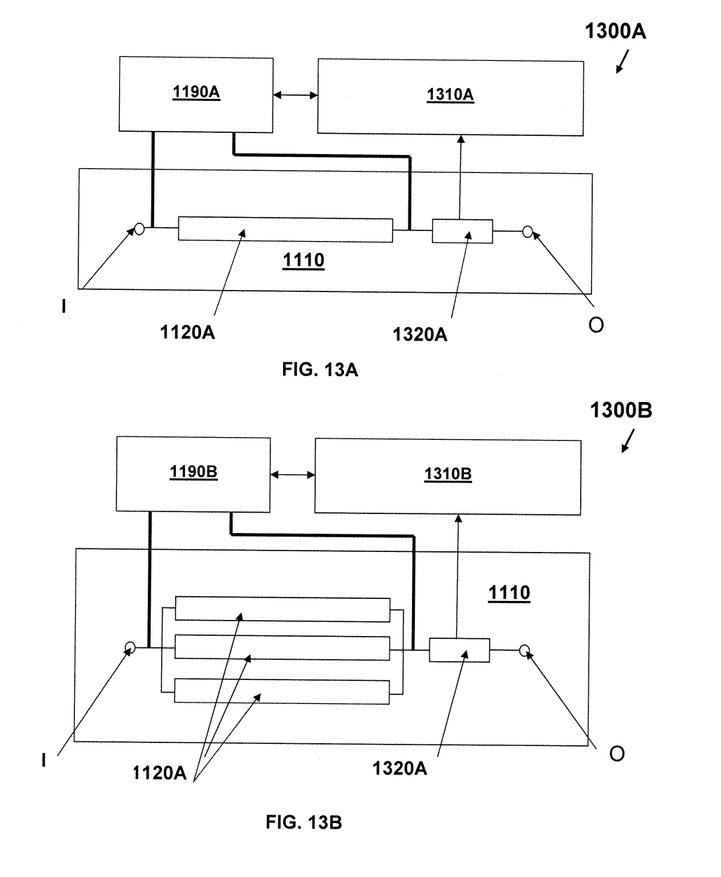

FIG. 13A is a top view block diagram of a ceramic-based EK pumping flow source 1300A. The source 1300A includes a ceramic-based substrate 1110A, an EK pump component 1120A in the substrate 1110A, a pump inlet I and a pump outlet defined in the substrate 1110A and in fluid communication with first and second ends of the pump 1120A, a flow sensor 1320A disposed between the second end of the pump 1120A and the outlet O, a power supply 1190A in electrical communication with a pumping medium of the component 1120A, and a flow control system 1310A in communication with the flow sensor 1320A and the power supply 1190A.

The inlet I is connected to a fluid reservoir. This reservoir is fabricated, for example, as a cavity inside the source 1300A, mounted onto the source 1300A, or as a satellite reservoir connected to the source 1300A via a fluid conduit.

Fluid exiting the pump component 1120A flows through the flow sensor 1320A co-fabricated as part of the source 1300A. The flow control system 1310A, implemented, for example, either on the substrate 1110A utilizing standard multi-layer circuit board fabrication implemented with ceramic materials, or off of the substrate 1110A, receives flow information from the flow sensor 1320A and adjusts either the current or voltage of the high-voltage EK pump power supply 1190A to achieve, for example, a selected flow set point.

Alternative embodiments include, for example, more than one EK pump. For example, FIG. 13B illustrates a system similar to that depicted in FIG. 13A, though employing multiple EK pumping channels to achieve higher flow rates.

FIG. 13B is a top view block diagram of a ceramic-based EK pumping flow source 1300B. The source 1300B includes a ceramic-based substrate 1110B, three EK pump components 1120B in the substrate 1110B, a pump inlet I and a pump outlet O defined in the substrate 1110B and in fluid communication with first and second ends of the pumps 1120B, a flow sensor 1320B disposed between the second end of the pumps 1120B and the outlet O, a power supply 1190B in electrical communication with a pumping medium of the components 1120B, and a flow control system 1310B in communication with the flow sensor 1320B and the power supply 1190B.

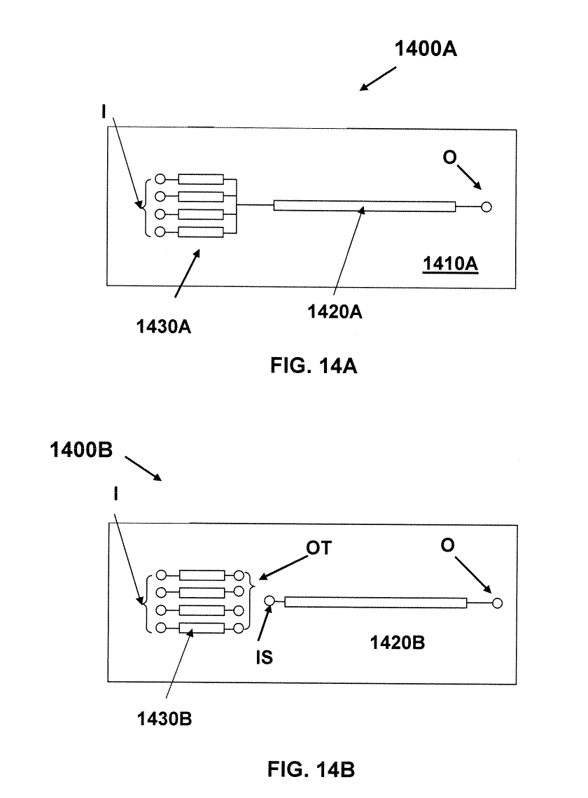

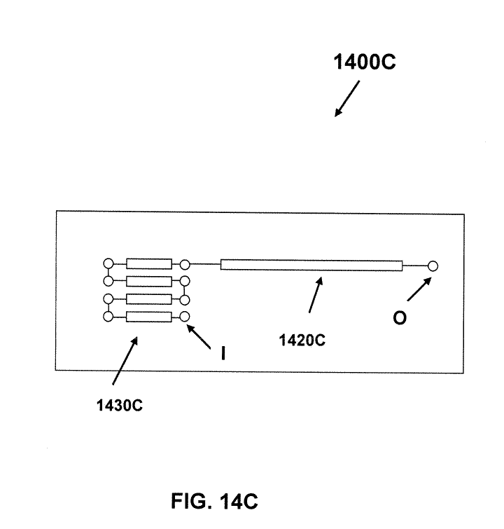

Next referring to FIGS. 14A, 14B and 14C, illustrative embodiments that include multiple trap columns are described. Use of more than one trap column in some instances is advantageous. For example, some embodiments, in accordance with the invention, of a nano-scale ceramic-based consumable device include more than one trap column to mitigate failure due to sample contamination occurring in a fluidic pathway preceding a separation column.

Some consumable ceramic-based devices of the invention provide extended use of a separation column by the inclusion of multiple trap columns. Accordingly, a nano-scale LC consumable optionally includes multiple trap columns that are individually fluidically addressed using external valving or on-substrate port selection.

FIG. 14A is a top view block diagram of a ceramic-based liquid-processing apparatus 1400A. The apparatus 1400A includes a ceramic-based substrate 1410A, multiple trap columns 1430A in the substrate 1410A, inlet ports I for each trap column 1430A, a separation column 1420A in the substrate 1410A and in fluidic communication at an inlet end with outlet ends of the trap columns 1430A and at an outlet end with an outlet port O defined in the substrate 1410A. The apparatus 1400A thus provides multiple trap columns having separate inlet vias, but all connected at a common junction with, for example, an analytical column(s).

Any one of the multiple trap columns 1430A is addressable by moving an inlet interface to the inlet port I of the column 1430A while plugging the inlet ports I of the remaining trap columns 1430A.

Alternatively, for example, multiple trap columns with independent inlet and outlet vias are constructed on a single chip, and external valving or on-substrate valves and fluidic interfaces are used to connect an HPLC injector to a selected trap inlet as well as connect the selected trap outlet to an analytical column inlet. For example, FIG. 14B is a top view block diagram of a ceramic-based liquid-processing apparatus 1400B. The apparatus 1400B includes a ceramic-based substrate 141 BA, multiple trap columns 1430B in the substrate 1410B, inlet ports I and outlet ports OT for each trap column 1430B, a separation column 1420B in the substrate 1410B and in fluidic communication at an inlet port IS and an outlet port O defined in the substrate 1410B.

Some embodiments of the invention entail nano-scale LC consumables with multiple trap columns having different stationary phases. A consumable with multiple trap columns with different stationary phases is usable, for example, for multidimensional separations such as ion-exchange/reverse-phase separation systems commonly used for, for example, complex peptide separations. Alternatively two serially connected trap columns are useable, for example, to digest a whole-protein sample using an immobilized enzyme such as trypsin in a first trap column, followed by a reverse-phase trap column to collect the peptides produced in the trypsin column.

For example, FIG. 14C is a top view block diagram of a ceramic-based liquid-processing apparatus 1400C. The apparatus 1400C includes a ceramic-based substrate 1410C, multiple trap columns 1430C connected in serial fashion in the substrate 1410B, an inlet port I for the first one of the trap columns 1430C, a separation column 1420C in the substrate 1410C and in fluidic communication with an outlet of the trap columns 1430C and having an outlet port O defined in the substrate 1410C.

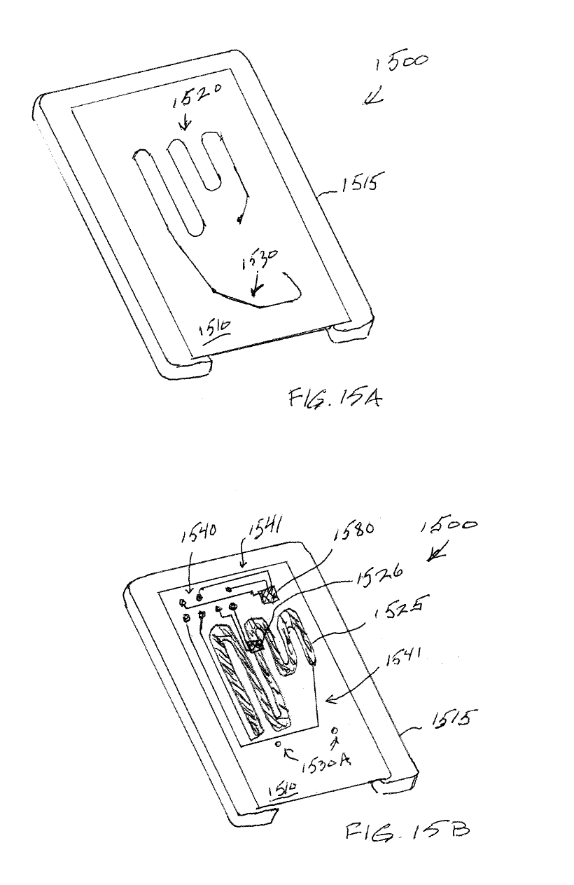

Referring next to FIGS. 15A and 15B, some embodiments of the invention incorporate electronic component(s) with a microfluidic ceramic-based substrate. Similar processing steps to those described above are optionally utilized to, for example, incorporate electronic circuits such as multilayered electronic circuits in ceramic-based apparatus of the invention. For example, some embodiments of the invention utilize co-fired metallization to integrate electronic elements with a ceramic-based substrate of a microfluidic system.

In some embodiments, a system includes on-substrate temperature control components including integrated resistance elements for temperature sensing and heating. Some alternative embodiments attach electronic component(s) (integrated circuits and/or passive components) onto the microfluidic co-fired substrate using printed circuit-like thick film systems to solder or otherwise attach electronic components.

Alternatively, some electronic components interact with on-substrate analog or digital devices (as flow or temperature sensors, heaters, and detection systems) via an a substrate interface such as contact pads. As one alternative, signal processing and consolidation of multiple on-substrate sensor and control systems in an analog or digital fashion provides a single analog or digital interface between the substrate and an external control system or user interface. Still other alternative embodiments include on-substrate electronic data storage components, such as an EEPROM or other re-writeable or permanent memory systems used, for example, to serialize devices, store usage history, or provide calibration information, factory test data, or usage methods. Host systems that interface with a consumable substrate optionally read or write data to on-substrate data storage units.

For example, FIG. 15A and FIG. 15B illustrate a three-dimensional view of a ceramic-based device 1500. Microfluidic components associated with a patterned layer of a substrate are shown in FIG. 1A and electronic components associated with a surface of the substrate are shown in FIG. 1B. The device 1500 includes a ceramic-based substrate 1510 that defines an analytical column 1520 and a trap column 1530 in communication with the analytical column 1520, an integrated heater 1525 disposed adjacent to the analytical column 1520, a temperature sensor 1526 disposed adjacent to a midsection of the heater 1525, an EEPROM data storage component 1580 attached to the substrate 1510, electrical interconnect 1541 variously connected to the heater 1525, sensor 1526, and component 1580, contact pads 1540 to provide an electrical interface for a host system to the interconnect 1541, and a frame 1515 that supports the substrate 1510.

The device 1500 is removably attached to a host LC or LC/MS system via a clamping device, which is any suitable clamping device; a suitable clamping device, for example, is similar to the clamp described with reference to FIG. 2B. The device 1500 communicates electrically with the host system via the contact pads 1540 and communicates fluidicly with the host via fluidic ports 1530A defined in the substrate 1520. Thus, when attached to a host system, the device 1500 receives electrical power and liquids from the host system, and communicates electronically with the host system.

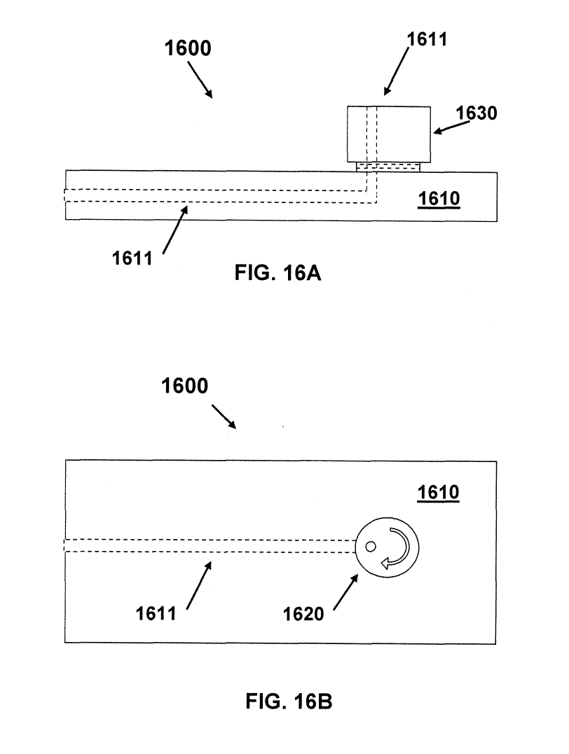

Next referring to FIG. 16A and FIG. 16B, some embodiments of a ceramic-based microfluidic substrate include multiple inlet and outlet ports, associated with various channels defined by the substrate, that require addressing for desired fluidic communication with a host system. A high-pressure fluidic interface for selective fluidic connections to such ports is obtained, for example, though use of a rotary or linear multi-port valve component.

For a broadly illustrative example, FIG. 16A is a side view block diagram and FIG. 16B is a top view block diagram of a portion of a valve portion 1600 of a ceramic-based microfluidic system. The valve portion 1600 includes a substrate 1610 defining a conduit 1611, a stator 1630 mounted adjacent to the substrate 1610, and a rotor 1620 disposed between the stator 1630 and the substrate 1610. The stator 1630 defines a fluidic via 1631 to connect with external fluidic components, and is in alignment with a port of the conduit 1611. The rotor 1620 defines an aperture that corresponds in diameter to the diameter of the fluidic via 1631 of the rotor 1620. The rotor 1620 is rotatably movable to either block or open a path between the fluidic via 1631 and the port of the conduit 1611 by appropriately positioning the aperture of the rotor 1620. The arrow indicates an angular direction of rotation of the rotor 1620.

In order to create a high-pressure fluidic seal, either the stator 1630, rotor 1620 or both are preferably made of a suitable compliant material. One suitable material is a polyether-ether-ketone, such as PEEK polymer (available from Victrex PLC, Lancashire, United Kingdom.) The stator 1630 and rotor 1620 are held together with enough force to maintain a substantially leak-free path while still permitting rotation of the parts against each other. In order to achieve high valve lifetimes (i.e. multiple actuations), compliant and hardened materials for the stator 1630 and rotor 1620 with sufficient stiffness and low friction are optionally used to decrease surface wear.

Some commercially available HPLC multi-port high-pressure valves such as a CHEMINERT® valve, available from Valco Instruments Co. Inc are suitable for some embodiments of the invention. These valves typically use a stator having multiple ports arranged in an arc that can be made to align with features on a rotor by rotating either part with respect to the other.

A valve is coupled to an LTCC microfluidic substrate in a variety of suitable ways. Because the ceramic substrate is typically hard, a compliant rotor is suitable for rotating and sealing against the substrate. The rotor has features that align with ports on the substrate upon rotation. For example, a single port on a rotor is alternately aligned with one of several ports on a LTCC device, blocking the other ports that are not aligned. Alternatively, a groove on a rotor fluidically connects two ports on a LTCC device or blocks one or both ports. Similarly, a groove in a rotor alternately connects two of three ports arranged in an arc. A variety of fluidic interfaces, related to those described here, are optionally used to address one of multiple trap columns on a LTCC-based nano-scale LC consumable device.

In view of the description provided herein, one having ordinary skill in the liquid chromatography arts will recognize that valves are optionally include to provide a variety of functions (such as flow switching, sample injection, and stream selection), and are attachable to a substrate in any suitable manner. For example, valves are attachable via the techniques described above with reference to the connectors 130, 230A.

Various illustrative implementations of the present invention may be applied to a variety of systems and/or methods involving fluid transport. As used herein, the terms “fluid”, “fluidic” and/or any contextual, variational or combinative referent thereof, are generally intended to include anything that may be regarded as at least being susceptible to characterization as generally referring to a gas, a liquid, a plasma and/or any matter, substance or combination of compounds substantially not in a solid or otherwise effectively immobile condensed phase. The terms “inlet” and “outlet” are generally understood to refer to any cross-sectional area or component feature of a device, the flux through which tends to translate fluid from a volume element substantially external/internal to a device to a volume element substantially internal/external to the device.

Variations, modifications, and other implementations of what is described herein will occur to those of ordinary skill in the art without departing from the spirit and the scope of the invention as claimed. For example, some embodiments include any one or combination of the following features: two or more separation columns; two or more trap columns; a ceramic-substrate that includes check valve(s), pump(s), and/or electronic devices such as memory devices, identification devices (such as A RFID), and/or display devices. Moreover, some integrated ceramic-based device including these features are suitable for use as consumable devices, due to low manufacturing cost. Accordingly, the invention is to be defined not by the preceding illustrative description but instead by the spirit and scope of the following claims.

What is claimed is:

1. A chemical-processing instrument, comprising;
a processing unit comprising sintered inorganic particles, the processing unit that surround a cavity defining a separation column in fluidic communication with an inlet port of the processing unit, wherein the cavity contains a stationary medium;
a pump configured to deliver a liquid comprising a solvent at a pressure sufficient for high-performance liquid chromatography; and
a connector in physical communication with the inlet port, and configured to provide a substantially leak-free connection for a conduit that carries the liquid delivered by the pump.

2. The instrument of claim 1, wherein the separation column has a width of less than about 500 μm.

3. The instrument of claim 1, wherein the separation column has a width of less than about 200 μm.

4. The instrument of claim 1, wherein the pressure is greater than about 2 kpsi.

5. The instrument of claim 4, wherein the pressure is greater than about 5 kpsi.

6. The instrument of claim 5, wherein the pressure is greater than about 20 kpsi.

7. The instrument of claim 1, further comprising an adhesive that attaches the connector to the processing unit.

8. The instrument of claim 1, wherein the connector comprises a housing configured to receive the conduit.

9. The instrument of claim 8, further comprising a sealing unit disposed between the housing and the processing unit.

10. The instrument of claim 9, wherein the sealing unit comprises a gasket.

11. The instrument of claim 10, wherein the gasket comprises an adhesive layer that attaches the gasket to the processing unit.

12. The instrument of claim 10, wherein the gasket has an area of less than about 0.05 square inch.

13. The instrument of claim 10, wherein the gasket has a gasket factor of at least about 1:1.

14. The instrument of claim 9, wherein the sealing unit comprises a material selected from the group consisting of polyimide, polyetheretherketone, tetrafluoroethylene, and polydimethylsiloxane.

15. The device of claim 8, wherein the connector further comprises at least one bolt that secures the housing to the processing unit.

16. The device of claim 1, wherein the connector comprises a clamp having opened and closed positions for, respectively, exchanging the processing unit and sealing the processing unit.

17. The device of claim 16, wherein the connector further comprises a pressure-adjustable component to select a pressure applied between the connector and the processing unit.

18. The device of claim 17, wherein the pressure-adjustable component comprises a piezoelectric material.

19. The device of claim 1, wherein the inlet port has a greater width than a width of a conduit defined by the processing unit that provides fluidic communication between the inlet port and the separation column.

20. The instrument of claim 1, wherein the processing unit further defines a trap column in fluidic communication with the inlet port and an inlet of the separation column.

21. The instrument of claim 20, further comprising a trap valve configured to permit a fluid passing through the trap column to exit the processing unit prior to entering the inlet of the separation column.

22. The instrument of claim 1, wherein the inorganic particles comprise a material selected from the group of materials consisting of a glass, a glass-crystalline ceramic, a crystalline ceramic, and a metal.

23. The instrument of claim 22, wherein the inorganic particles comprise a ceramic oxide selected from the group consisting of aluminum oxide, zirconium oxide, and stabilized zirconia.

24. The instrument of claim 1, wherein the inorganic particles comprise a ceramic oxide, a ceramic non-oxide, or a ceramic oxide and a ceramic non-oxide.

25. The instrument of claim 1, wherein the processing unit is mostly crystalline.

26. The instrument of claim 1, wherein the processing unit further comprises an interfacial material disposed between the inorganic particles.

27. The instrument of claim 26, wherein the interfacial material is substantially glassy.

28. The instrument of claim 1, wherein the instrument is an ion chromatograph or a liquid chromatograph.

29. The instrument of claim 29, wherein the instrument is a HPLC instrument.

30. The instrument of claim 1, further comprising a thick-film resistor disposed adjacent to the separation column.

31. The instrument of claim 1, wherein the separation column is distributed within at least two layers of the processing unit.

32. The instrument of claim 1, wherein the processing unit defines at least two separation columns in a parallel relationship.

33. A method for separating a chemical sample, comprising;
providing a processing unit comprising sintered inorganic particles that surround a cavity defining a separation column in fluidic communication with an inlet port of the processing unit, wherein the cavity contains a stationary medium; and
pumping a fluid comprising a sample into the separation column at a pressure sufficient for high-performance liquid chromatography.

34. The instrument of claim 1, wherein the pressure is greater than about 2 kpsi.

35. The instrument of claim 34, wherein the pressure is greater than about 5 kpsi.

36. The instrument of claim 35, wherein the pressure is greater than about 10 kpsi.

37-192. (canceled)
